(19) United States
(12) Patent Application Publication
(10) Pub. No.: US 2011/0233941 A1
(43) Pub. Date: Sep. 29, 2011

(54) SOUND WAVE RESONANCE GENERATOR

(75) Inventor: In-Ho Jee, Gyeonggi-do (KR)

(73) Assignee: TAE CHANG N.E.T. CO., LTD., Bucheon-si Gyeonggi-do (KR)

(21) Appl. No.: 13/132,401

(22) PCT Filed: Dec. 3, 2008
(86) PCT No.: PCT/KR2008/007129

§ 371 Date: Jun. 2, 2011

(51) Int. Cl. F03G 7/08

(52) U.S. Cl. 290/1 R

(57) ABSTRACT

The present invention relates to a sound wave resonance generator that is placed on underground railways of subways, in tunnels of surface streets, and around a landing field of the airplane of an airport, from which big noises are generated, thereby collecting surrounding noises around there, converting the collected noises into vibration motions of resonators, converting the vibration motions of the resonators into an electrical energy, and making the use of the electrical energy as a power source for driving a load.

### TECHNICAL FIELD

The present invention relates to a sound wave resonance generator that is placed in tunnels of roads or railways or around a landing field of airplanes, from which big noises are generated, thereby collecting surrounding noises around there, converting the collected noises into vibration motions of resonators, converting the vibration motions of the resonators into an electrical energy, and making the use of the electrical energy as a power source.

### BACKGROUND ART

Generally, electricity has been producing from a number of energy sources such as thermal power, nuclear power, hydroelectric power, solar power, wind power, wave power, and tide power, which need large-sized power generation equipment.
As much interest in non-polluting energy is increased, recently, many studies are made on the technologies for obtaining electricity from energy sources like solar power, wind power, wave power, tide power and so on, and additionally, a variety of methods have been proposed in view of energy production.

By the way, sound waves are a kind of energy that has wavelength, but no power generation equipment using the sound waves has been known yet. Big noises are generated on the subway railways, landing fields, and tunnels, but they just disappear, without any utilization as energy.

### DISCLOSURE OF INVENTION

### Technical Problem

Accordingly, it is an object of the present invention to provide a sound wave resonance generator that can produce electricity by using sound waves.

It is another object of the present invention to provide a sound wave resonance generator that is placed on underground railways of subways, in tunnels of surface streets, and around a landing field of airplane of an airport, from which big noises are generated, thereby collecting surrounding noises around there, converting the collected noises into vibration, converting the vibration into electricity.

### Technical Solution

To achieve the above objects, there is provided a sound wave resonance generator including: a sound-collecting tube for collecting surrounding sounds thereinto; a resonance tank connected to the rear end of the sound-collecting tube so as to resonate the collected sounds; a plurality of resonators attached on the outer periphery of the resonance tank in such a manner as to be resonated by the sound waves transmitted through the resonance tank and to generate vibration; an actuator disposed on one side end portion of each resonator in a resonance direction in such a manner as to be reciprocally moved by the resonance of each resonator and having a plurality of magnets arranged in turn in such a manner as to have different polarities from each other; and a stator having coils mounted over and below the actuator so as to induce an electromotive force by the reciprocal movements of the actuator and to generate and output power therefrom.

According to the present invention, the sound wave resonance generator further includes: an outer casing spaced apart from the resonance tank by a predetermined distance in such a manner as to be opened on the both end surfaces thereof, thereby forming a resonance chamber where the resonators, the actuators, and the stators are disposed, supporting the resonance tank thereagainst, and fixedly mounting the stators thereon; a plurality of diaphragms disposed between each of the opened both end surfaces of the outer casing and the resonance tank in such a manner as to close the resonance chamber where the resonators are disposed and to allow air to flow during the resonance of the resonators; a resonance-adjusting plate disposed at the inside of the resonance tank so as to adjust the volume of the inside area of the resonance tank; and a resonance adjustor mounted at the rear end portion of the resonance tank in such a manner as to be exposed to the outside, thereby adjusting the forward and backward movements of the resonance-adjusting plate.

According to the present invention, the sound-collecting tube is a horn-like tube that becomes large toward the outside end portion thereof and small toward the inside end portion thereof connected to the resonance tank and has a spiral protruding part formed along the inside wall thereof, thereby taking a cochlea-like shape.

According to the present invention, the stator is configured to output an elecromotive force induced therefrom to the outside, such that the outputted electromotive force is passed through a voltage-stabilizing circuit and a dual voltage circuit and is then charged to a charging battery or is supplied to driving power for a load (for example, an illuminating light).

According to the present invention, the sound wave resonance generator is placed on the lateral walls around underground railways of subways, in the landing field of airports, and in tunnels of surface streets, thereby collecting surrounding noises, producing electricity from the collected noises, and driving a load by using the electricity. If the outside sounds are collected to the sound-collecting tube, the sound waves are transmitted to the interior of the resonance tank, and then, the resonance tank is resonated by the collected sound waves. Next, the resonators attached on the outer peripheral wall of the resonance tank become vibrated.

Each of the resonators is vibrated on the end portion thereof by the sound waves transmitted through the resonance tank. At this time, the actuator attached on one side end portion of each resonator is vibrated horizontally in accordance with the vibration of each resonator. Since the actuator has the plurality of magnets and the stator has the coils mounted over and below the actuator, if the actuator is vibrated horizontally, the electromotive force is induced to the stator composed of the coils by the formation of the magnetic field from the actuator, thereby generating power therefrom. The power is charged and boosted by using an external power device so as to be used as the driving power for a load.

The resonance chamber formed by the outer casing is closed by means of the diaphragms formed at the both ends thereof, such that the air generated upon the resonance of the resonators can flow, the variation of air pressure can be prevented, and stable resonance can be achieved. The resonance tank has the resonance-adjusting plate mounted at the inside thereof so as to adjust the volume of the inside area of the resonance tank, which means a standing wave ratio, i.e., a maximum resonance point is adjusted. Since the resonance-adjusting plate is forwardly and backwardly moved by the manipulation of the resonance adjustor mounted at the outside thereof, the volume of the inside area of the resonance tank can be adjusted appropriately.

### Advantageous Effects

According to the present invention, there is provided the sound wave resonance generator that collects surrounding sounds, converts the collected sounds into vibration through the resonators, allows the actuators to be horizontally reciprocated by the vibration of the resonators, and induces the electromotive force to the stators composed of coils, thereby producing electricity, such that the sound wave resonance generator is located on a place where big noises are generated so as to convert the noises into electrical power used as load-driving power. Therefore, the sound wave resonance generator is installed on the place where big noises are generated, for example, on the underground railways of subways, in the landing field of airport, and in tunnels of surface streets, such that the electricity produced therefrom can be used as the driving power for illuminating lights.

### BRIEF DESCRIPTION OF THE DRAWINGS

FIG. 1 is a sectional view showing a configuration of a sound wave resonance generator according to the present invention.

FIGS. 2 and 3 are sectional and perspective views showing the actuator and stator of the sound wave resonance generator according to the present invention.

FIG. 4 is a horizontal sectional view showing the sound wave resonance generator according to the present invention.

### MODE FOR THE INVENTION

Hereinafter, an explanation on a sound wave resonance generator according to a preferred embodiment of the present invention will be given with reference to the attached drawings.

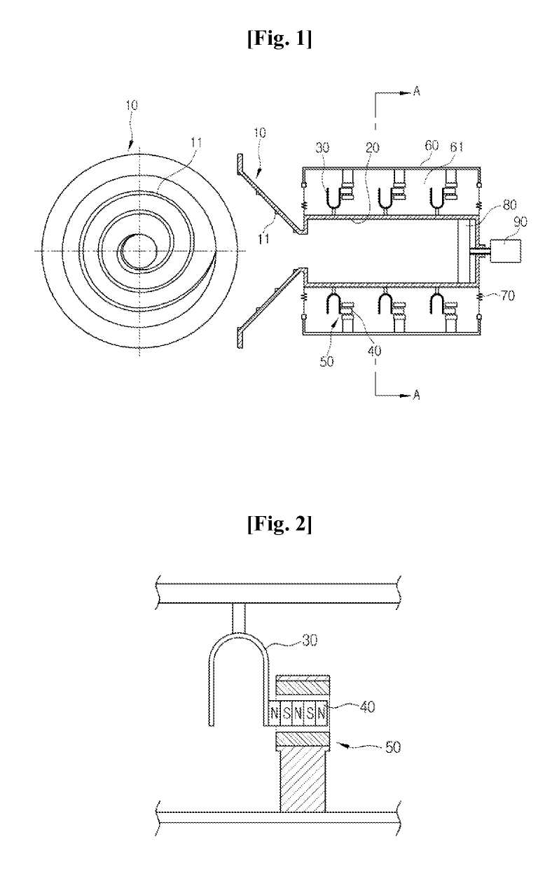

FIG. 1 is a sectional view showing a configuration of a sound wave resonance generator according to the present invention.

According to the present invention, there is provided a sound wave resonance generator including: a sound-collecting tube 10 for collecting surrounding sounds thereinto; a resonance tank 20 connected to the rear end of the sound-collecting tube 10 so as to resonate the collected sounds; a plurality of resonators 30 attached on the outer periphery of the resonance tank 20 in such a manner as to be resonated by the sound waves transmitted through the resonance tank 20 and to generate vibration therefrom; an actuator 40 disposed on one side end portion of each resonator 30 in a resonance direction in such a manner as to be reciprocally moved by the resonance of each resonator 30 and having a plurality of magnets arranged in turn in such a manner as to have different polarities from each other; and a stator 50 having coils mounted over and below the actuator 40 so as to induce an electromotive force by the reciprocal movements of the actuator 40 and to generate and output power therefrom.

According to the present invention, the sound wave resonance generator further includes: an outer casing 60 spaced apart from the resonance tank 20 by a predetermined distance in such a manner as to be opened on the both end surfaces thereof, thereby forming a resonance chamber 61 where the resonators 30, the actuators 40, and the stators 50 are disposed, supporting the resonance tank 20 thereagainst, and fixedly mounting the stators 50 thereon; a plurality of diaphragms 70 disposed between each of the opened both end surfaces of the outer casing 60 and the resonance tank 20 in such a manner as to close the resonance chamber 61 where the resonators 30 are disposed and to allow air to flow during the resonance of the resonators 30; a resonance-adjusting plate 80 disposed at the inside of the resonance tank 20 so as to adjust the volume of the inside area of the resonance tank 20; and a resonance adjustor 90 mounted at the rear end portion of the resonance tank 20 in such a manner as to be exposed to the outside, thereby adjusting the forward and backward movements of the resonance-adjusting plate 80.

FIGS. 2 and 3 are sectional and perspective views showing the actuator and stator of the sound wave resonance generator according to the present invention. Each of the stators 50 has the coils mounted over and below the actuator 40 corresponding thereto at the inside of a circular bracket thereof in such a manner as to permit the electromotive force to be generated and outputted from the coils by the reciprocal movement of the actuator 40, and the bracket of the stator 50 is fixedly mounted on the outer casing 60. Each of the actuators 40 has a plurality of magnets arranged in turn in such a manner as to have different polarities from each other.

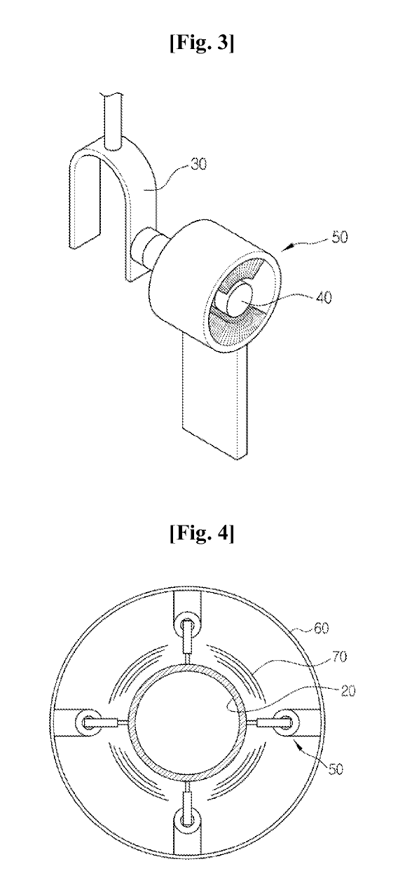

FIG. 4 is a horizontal sectional view showing the sound wave resonance generator according to the present invention. As shown, the plurality of resonators 30 are disposed on the outer periphery of the resonance tank 20, and according to the preferred embodiment of the present invention, the resonators 30 are disposed in four directions along the outer periphery of the resonance tank 20. Each of the resonators 30 has the actuator 40, and the stator 50 is mounted correspondingly to each actuator 40.
The sound-collecting tube 10 is a horn-like tube that becomes large toward the outside end portion thereof and small toward the inside end portion thereof connected to the resonance tank 20 and has a spiral protruding part 11 formed along the inside wall thereof, thereby taking a cochlea-like shape.

Even though not in the drawing, also, a power device is further provided to stabilize the output of the stator 50 and to supply the output as driving power for a load.
The output of the stator 50 through the power device is passed through a rectifier circuit, a voltage-stabilizing circuit, and a dual voltage circuit and is then charged to a charging battery or is then supplied to driving power for a load (for example, an illuminating light).

According to the present invention, the sound wave resonance generator is placed on the lateral walls around underground railways of subways, in the landing field of airports, and in tunnels of surface streets, thereby collecting surrounding noises, producing electricity from the collected noises, and driving a load by using the electricity. If the outside sounds are collected to the sound-collecting tube 10, the sound waves are transmitted to the interior of the resonance tank 20, and then, the resonance tank 20 is resonated by the collected sound waves. Next, the resonators 30 attached on the outer peripheral wall of the resonance tank 20 become vibrated. As shown, the sound-collecting tube 10 has a cochlea-like shape in such a manner as to form the spiral protruding part 11 along the inside wall thereof, thereby serving to collect the sound waves generated from the outside to the resonance tank 20 via the spiral protruding part 11. Each of the resonators 30 is vibrated on the end portion thereof by the sound waves transmitted through the resonance tank 20. Each of the resonators 30 is formed of a steel plate having an appropriately horseshoe magnet-like shape. At this time, the actuator 40 attached on one side end portion of each resonator 30 is vibrated horizontally in accordance with the vibration of the resonator 30 corresponding thereto.

As shown in FIG. 2, the actuator 40 has the plurality of magnets, and the stator 50 has the coils mounted over and below the actuator 40. When the actuator 40 is vibrated horizontally, the electromotive force is induced to the stator 50 composed of the coils by the formation of the magnetic field from the actuator 40, thereby generating power therefrom. The power is charged and boosted by using an external power device so as to be used as the driving power for a load.

The resonance chamber 61 formed by the outer casing 60 is closed by means of the diaphragms 70 formed at the both ends thereof, such that the air generated upon the resonance of the resonators 30 can flow, the variation of air pressure can be prevented, and stable resonance can be achieved.

According to the present invention, therefore, the sound wave resonance generator can collect the noises generated on the underground railways of the subways, on the landing field of airports, and in the tunnels of surface streets by means of the sound collecting tube 10, vibrate the actuators 40 by the collected sounds by means of the resonance tank 20 and the resonators 30, and convert the vibration into an electrical energy by means of the stators 40.

1. A sound wave resonance generator comprising:
a sound-collecting tube 10 for collecting surrounding sounds thereinto;
a resonance tank 20 connected to the rear end of the sound-collecting tube 10 so as to resonate the collected sounds;
a plurality of resonators 30 attached on the outer periphery of the resonance tank 20 in such a manner as to be resonated with the sound waves transmitted through the resonance tank 20 and to generate vibration therefrom;
an actuator 40 disposed on one side end portion of each resonator 30 in a resonance direction in such a manner as to be reciprocally moved by the resonance of each resonator 30 and having a plurality of magnets arranged in turn in such a manner as to have different polarities from each other; and a stator 50 having coils mounted around the actuator 40 so as to induce an electromotive force by the reciprocal movements of the actuator 40 and to generate and output power therefrom.

2. The sound wave resonance generator according to claim 1, further comprising:
an outer casing 60 spaced apart from the resonance tank 20 by a predetermined distance in such a manner as to be opened on the both end surfaces thereof, thereby forming a resonance chamber 61 where the resonators 30, the actuators 40, and the stators 50 are disposed, supporting the resonance tank 20 thereagainst, and fixedly mounting the stators 50 thereon;
a plurality of diaphragms 70 disposed between each of the opened both end surfaces of the outer casing 60 and the resonance tank 20 in such a manner as to close the resonance chamber 61 where the resonators 30 are disposed and to allow air to flow during the resonance of the resonators 30;
a resonance-adjusting plate 80 disposed at the inside of the resonance tank 20 so as to adjust the volume of the inside area of the resonance tank 20; and a resonance adjustor 90 mounted on the rear end portion of the resonance tank 20 in such a manner as to be exposed to the outside, thereby adjusting the forward and backward movements of the resonance-adjusting plate 80.

3. The sound wave resonance generator according to claim 1, wherein each of the stators 50 has the coils mounted inside of a circular bracket.

4. The sound wave resonance generator according to claim 1, wherein the resonators 30 are disposed in four directions along the outer periphery of the resonance tank 20, each of the resonators 30 having the actuator 40, and the stator 50 is mounted correspondingly to the actuator 40.

5. The sound wave resonance generator according to claim 1, wherein the sound collecting tube 10 is a horn-like tube that becomes large toward the outside end portion thereof and small toward the inside end portion thereof connected to the resonance tank 20 and has a spiral protruding part 11 formed along the inside wall thereof, thereby taking a cochlea-like shape.
